(19) United States
(12) Patent Application Publication
(10) Pub. No.: US 2015/0341245 A1
(43) Pub. Date: Nov. 26, 2015

(54) NETWORK MANAGEMENT MODEL EXTENSION

(71) Applicant: TELEFONAKTIEBOLAGET L M ERICSSON (PUBL), Stockholm (SE)

(72) Inventors: Roberta Merlo, Genova (IT); Franco Ferioli, Genova (IT); Carla Marcenaro, Genova (IT); Maurizio Pighetti, Genova (IT)

(21) Appl. No.: 14/648,711

(22) PCT Filed: Aug. 28, 2013
(86) PCT No.: PCT/EP2013/067837

§ 371 Date: May 31, 2015

Related U.S. Application Data
(60) Provisional application No. 61/733,649, filed on Dec. 5, 2012.

(51) Int. Cl. H04L 12/26; H04L 12/24

(52) U.S. Cl. CPC H04L 43/0876; H04L 41/04

(57) ABSTRACT

A communications network has network elements and management parts and a stored model of the network. The network elements have a controllable energy consumption status represented explicitly in the stored model. Indications of the controllable energy consumption status are passed between the management parts and network elements in a format which is compatible with the format of the model, such as by extension of TMF 814. Representing such energy status information more explicitly means it can be exchanged or distributed more efficiently, and passing the indication in a format compatible with a standard format of the network model, means a discovery request can be more easily used at various different management levels, and by various different parts of the network.

### FIELD

The present invention relates to methods of operating a communications network, to corresponding apparatus having a processor and memory operative to carry out such methods, and to corresponding computer programs.

### BACKGROUND

As is explained in the IETF document “draft-ietf-eman-framework-05” network management is currently divided into the five main areas defined in the ISO Telecommunications Management Network model: Fault, Configuration, Accounting, Performance, and Security Management (FCAPS) [X.700]. Absent from this management model is any consideration of Energy Management, which is now becoming more important. Energy Management has particular challenges in that a power distribution network is responsible for the supply of energy to various devices and components, while a separate communication network is typically used to monitor and control the power distribution network.

This EMAN framework document defines a framework for providing Energy Management for devices within or connected to communication networks. The framework describes how to identify, classify and provide context for a device in a communications network from the point of view of Energy Management. The identified device or identified components within a device can then be monitored for Energy Management by obtaining measurements for Power, Energy, Demand and Power Quality. An Energy Object state can be monitored or controlled by providing an interface expressed as one or more Power State Sets.

The IETF EMAN framework also defines a subset of the Management Information Base (MIB) for power and energy monitoring of devices. Among other possible aspects of the generalized power monitoring MIB, it defines also “Power States” in accordance with IEEE1621, DMTF, ACPI and EMAN. The latter attempts to provide a uniform standard to model the different power consumption levels of an equipment. https://datatracker.ietf.orq/doc/draft-ietf-eman-energy-monitoring-mib/

The Management Information Base (MIB) can be for use in energy management of devices within or connected to communication networks. The MIB modules can provide a model for energy management, including monitoring for power state and energy consumption of networked elements. This MIB takes into account the Energy Management Framework [EMAN-FRAMEWORK], which in turn, is based on the Requirements for Energy Management [EMAN-REQ].

It is known to provide an object oriented model of a network for use by network management systems. Objects can be provided to represent for example managed network elements, element management systems EMS, multilayer subnetworks MLSN, for managing large numbers of such elements, termination points TP, contained termination points CTP, topological links TL, alarms, and threshold crossing alerts TCA. An NMS can be configured to maintain such a model by sending discovery requests through the network to discover topology, properties and status. It is known to manage such networks based on the model, and to control their network elements.

### SUMMARY

Embodiments of the invention provide improved methods and apparatus. According to a first aspect of the invention, there is provided a method of operating a communications network having network elements for handling data traffic and having management parts for managing the network elements using a stored model which represents the communications network in a format, at least one of the network elements having an energy consumption status which can be controlled. The energy consumption status of the at least one of the network elements is represented in the stored model, and an indication of the controllable energy consumption status of at least one of the network elements is passed between one of the management parts and either of: another of the management parts and; at least one of the network elements. This indication has a format which is compatible with the format of the model. By representing such energy status information more explicitly, it can be exchanged or distributed more efficiently. This can help enable better energy aware network management at different parts of the network for example. By passing the indication in a format compatible with a standard format of the network model, the discovery request can be more easily used at various different management levels, and by various different parts of the network. This also contributes to improving the efficiency of the information exchange, leading to better energy aware network management for example, for a given overhead in processing and communications resources. See FIGS. 1 and 2 for example.

Any additional features can be added to those set out above, or disclaimed from such sets of features, and some such additional features are described below in more detail. One such additional feature is the indication comprising which of the network elements has an energy consumption status controllable by the network management system, and which of the network elements has an energy consumption status which can be controlled but not externally by the network management system. This can help enable the NMS to distinguish different levels of control of energy consumption by network elements. See FIG. 4 for example.

Another such additional feature is the representation of energy consumption status in the stored model comprising an object representing an energy consumption status of a respective one of the network elements, and the indication comprising information associated with said object. Preferably, the object representing the energy consumption status of a respective one of the network elements is an additional object to other objects representing the same entity. This additional object means other objects representing same entity need not be changed, thus backward compatibility is facilitated. See FIG. 4 for example.

Another such additional feature is the representation of energy consumption status in the stored model comprising an energy consumption profile for a group of the network elements, the energy consumption profile representing an aggregation of the controllable energy consumption statuses of the network elements in the group, and the indication comprising information associated with the energy consumption profile. The profile assembles information which is otherwise spread across different parts of the mode, and this aggregated information helps enable NMS to process it faster and more efficiently and enables scalability. See FIG. 4 for example.

Another such additional feature is updating the energy consumption profile according to a change in the controllable energy consumption status detected at one of the network elements of the group. This is one direction of updating, to enable the model to reflect the reality. See FIG. 3 for example.

Another such additional feature is the further step of controlling the energy consumption status of the network elements by the steps of altering the energy consumption profile, and causing the energy consumption statuses of the group of network elements to adapt to correspond to the altered energy consumption profile. This is the other direction of updating, to adapt the model to reflect the desired change and cause the reality in the network elements to be changed to follow the changes shown in the model as desired. See FIG. 6 for example.

Another such additional feature is the management parts comprising a network management system, and the step of passing comprising sending a discovery request from a network management system and receiving in response the indication. This can encompass information exchange between different layers of the NMS, or information exchange between remote NMSs for example, such as legacy NMSs, or an NMS for a part of the network controlled by a different carrier organisation for example. See FIGS. 2, and 7 to 10 for example.

Another such additional feature is the management parts comprising an element management system for managing at least one of the network elements, the passing step comprising passing from the element management system, the indication in respect of the controllable energy consumption status of the network elements managed by the element management system. Such an EMS can also aggregate or concentrate information flows and help the NMS to process more efficiently and improve scalability. See FIGS. 2 and 7 to 10 for example.

Another aspect provides a computer program for carrying out the methods having the features set out above.

Another aspect of the invention provides apparatus for use in a communications network, the communications network having network elements for handling data traffic and having management parts for managing the network elements using a stored model which represents the communications network in a format, at least one of the network elements having an energy consumption status which can be controlled. The apparatus has a processor and a memory, the memory containing instructions executable by said processor to update the stored model with a representation of the energy consumption status of the at least one of the network elements in the stored model. The instructions can also cause the processor to pass an indication of the controllable energy consumption status of at least one of the network elements between one of the management parts and either of: another of the management parts and; at least one of the network elements. The indication has a format which is compatible with the format of the model.

Another such additional feature is the indication comprising which of the network elements has an energy consumption status controllable by the network management system, and which of the network elements has an energy consumption status which can be controlled but not externally by the network management system.

Another such additional feature is the representation of the energy consumption status in the stored model comprising an object representing an energy consumption status of the indicated network elements which have a controllable energy consumption status, and the indication comprising information associated with said object. Another such additional feature is the apparatus being configured to represent the energy consumption status in the stored model at least as an energy consumption profile for a group of the network elements, the energy consumption profile representing in a aggregated form the controllable energy consumption statuses of the network elements in the group, and the indication comprising information associated with the energy consumption profile.

Another such additional feature is the apparatus also being operative to update the energy consumption profile in the model according to a change in the controllable energy consumption status of one of the network elements of the group.

Another such additional feature is the apparatus also being operative to control the energy consumption status of the network elements by altering the energy consumption profile, and causing the energy consumption statuses of the group of network elements to correspond to the altered profile.

Another such additional feature is the apparatus comprising a network management system configured such that the passing of the indication comprises sending a discovery request and receiving the indication in response. Another such additional feature is the apparatus comprising an element management system, the element management system being configured to manage at least one of the network elements, and being configured to pass the indication to the one of the management parts, the indication comprising the controllable energy consumption status of the network elements managed by the element management system.

Any of the additional features can be combined together and combined with any of the aspects. Other effects and consequences will be apparent to those skilled in the art, especially over compared to other prior art. Numerous variations and modifications can be made without departing from the claims of the present invention. Therefore, it should be clearly understood that the form of the present invention is illustrative only and is not intended to limit the scope of the present invention.

### BRIEF DESCRIPTION OF THE DRAWINGS

How the present invention may be put into effect will now be described by way of example with reference to the appended drawings, in which:

FIG. 1 shows a schematic view of a first embodiment having elements, stored model, and management parts,

FIG. 2 shows a schematic view of a second embodiment having management layers and using TMF 814,

FIG. 3 shows steps according to an embodiment,

FIG. 4 shows steps according to a further embodiment with an additional object,

FIG. 5 shows steps according to a further embodiment with an energy profile,

FIG. 6 shows steps according to a further embodiment with control steps,

FIG. 7 shows a time chart of embodiment having exchanges between NMS and EMS,

FIGS. 8, 9, and 10 show schematic views of examples showing NMS controller and PCE, and

FIGS. 11, 12 show schematic views of embodiments combining power consumption control and energy aware path computation.

### DETAILED DESCRIPTION

The present invention will be described with respect to particular embodiments and with reference to certain drawings but the invention is not limited thereto but only by the claims. The drawings described are only schematic and are non-limiting. In the drawings, the size of some of the elements may be exaggerated and not drawn to scale for illustrative purposes.

### DEFINITIONS

Where the term “comprising” is used in the present description and claims, it does not exclude other elements or steps and should not be interpreted as being restricted to the means listed thereafter. Where an indefinite or definite article is used when referring to a singular noun e.g. “a” or “an”, “the”, this includes a plural of that noun unless something else is specifically stated.

Elements or parts of the described nodes or networks may comprise logic encoded in media for performing any kind of information processing. Logic may comprise software encoded in a disk or other computer-readable medium and/or instructions encoded in an application specific integrated circuit (ASIC), field programmable gate array (FPGA), or other processor or hardware.

References to nodes can encompass any kind of switching node, not limited to the types described, not limited to any level of integration, or size or bandwidth or bit rate and so on.

References to software can encompass any type of programs in any language executable directly or indirectly on processing hardware.

References to processors, hardware, processing hardware or circuitry can encompass any kind of logic or analog circuitry, integrated to any degree, and not limited to general purpose processors, digital signal processors, ASICs, FPGAs, discrete components or logic and so on.

References to a processor are intended to encompass implementations using multiple processors which may be integrated together, or co-located in the same node for example.

### ABBREVIATIONS

### ASAP Alarm Severity Assignment Profile

### CORBA Common Object Request Broker Architecture

### EA Energy Aware

### EA NMS Energy Aware Network Manager System

### EAO Energy Aware Object

### EM Element Manager

### EMS Element Management System

### MLSN Multi Layer SubNetwork

### MTNM Multi Technology Network Management

### OAM Operations And Maintenance

### OO Object-Oriented

PCE Path computation Engine

### SRS Software Requirements Specification

### TCA Threshold Crossing Alert

TL Topological Link, is primarily an administrative object used to convey a relationship between two TPs.

### TMF TeleManagement Forum

TMF814 Protocol using CORBA specialized for MTNM communication.

### TP Termination Point

### REFERENCES

[1] http://www.tmforum.orq/browse.aspx
[2] TMF814 Multi Technology Network Management IDL Solution Set R3.5
[3] TMF 513 Version 3.1 Multi-Technology Network Management Business Agreement R3.5

### Introduction

By way of introduction to the embodiments, how they address some issues with conventional designs will be explained. ECONET is a European project aimed at studying and exploiting dynamic adaptive technologies (based on standby and performance scaling capabilities) for wired network devices that allow saving energy when a device (or part of it) is not used. ECONET has three main axes: Green Technologies for Network Device Data Plane, Green Strategies at the Control Plane, and a Green Abstraction Layer. This involves investigating network-specific capabilities being developed to optimize the power management features (e.g. standby and power scaling primitives). Regarding the control plane, local and distributed frameworks will be developed for energy-efficient flexible and cognitive network OAM, to enable dynamic, scalable, ad-hoc optimized resource allocation in terms of trade-off between energy consumption and network performance, as well as differentiated performance, fault-tolerance and robustness levels. The abstraction layer will involve a standard and general purpose interface for exposing and controlling the novel green capabilities and functionalities, realized with different typologies of network equipment and of HW technologies, towards “general purpose” OAM frameworks. This research axis will be the key for the integration and the development of energy-aware device prototype platforms, including both data-plane green capabilities and control strategies, for project dissemination, demonstration and proof-of-concept activities. Moreover, it will lead to the definition of novel device internal standards for managing and monitoring energy and performance profiles.

The Green Abstraction Layer is specifically conceived to hide the implementation details of energy-saving approaches, as well as to provide standard interfaces and methodologies for interactions between heterogeneous green capabilities and HW technologies, on one hand, and energy-aware control and monitoring frameworks, on the other hand.

An Energy Aware Network Management System (EA NMS) will be developed inside the ECONET project able to manage the different equipment provided by the partners. Each partner can use their preferred protocol to exchange data with EA NMS. The abstraction layer will provide an adapter for each protocol to overcome incompatibilities between protocols.

### Introduction to Features of Embodiments

At present there is no way of using standards based models of networks, such as TMF, to manage such green network capabilities as they don't have explicit representations of such green capabilities. Embodiments described below introduce explicit energy aware information in a network model, and introduce distribution of such information in a compatible format. In some examples this involves a TMF manager in order to have services to obtain data about energy management by a Network Element (NE), card or a single port in a network.

Power Modes (also referred to as power consumption modes or power management modes) such as low power, fast sleeping, stand-by, etc. are incorporated into the basic design, and adaptation of the performances (and hence of power consumption) can be carried out according to the actual traffic load level. By means of the methods herein described, there can be more energy efficient Telecom operation by dynamic performance and consumption adaptation to any arbitrary traffic load situation, for example as a function of day-time, of specific area service (e.g. vacation villages area, business area), and so on.

Embodiments can provide power-saving methods providing effective capability to lower the performances of lightly utilized communications apparatus to save the power consumed, by introducing novel network energy management capabilities, which can include multiple low power modes, idle and stand-by logic states, to dynamically adapt performances and therefore power consumption, to actual traffic load.

To this end, there are explained techniques, mechanisms and control criteria suitable for various types of communications apparatus in the form of any telecom network element (transport, access, wireless, routers, etc.), enabling energy saving by dynamically adapting network capacities and resources to current traffic loads and user requirements, while ensuring end-to-end quality of service.

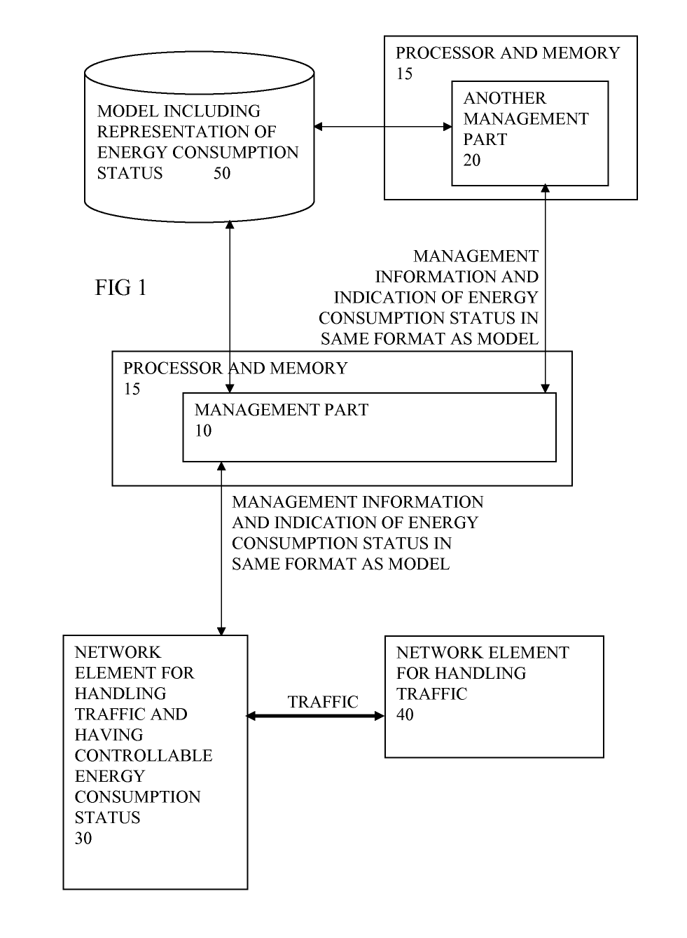

### FIG. 1, First Embodiment Having Elements, Stored Model, and Management Parts

FIG. 1 shows a schematic view of a first embodiment, showing apparatus features. A store 50 stores a model of the network with entities such as network elements or links, or abstract entities such as alarms, represented in a given format. The model includes a representation of energy consumption status of network elements or groups of such elements. Coupled to the store is a management part 10 for managing the network using the stored model. This is implemented typically using a processor and memory 15. The management part is coupled to many network elements, one such network element 30 is shown for handling traffic and having a controllable energy consumption status. Another network element 40 is shown to represent a typical case that not all network elements have controllable energy consumption status. A path for traffic flow between the network elements is also shown.

A management information path is shown between the management part 10 and the network element 30 for passing management information with an indication of energy consumption status in a format compatible with the format of the stored model. Such information can pass in either direction, for example as a command to the network element to control its energy consumption status, or as a status update, to report the status to the management part.

Also shown is another management part 20, coupled by a management path to the management part 10, to enable management information to be exchanged between management parts. Again the “another management part” 20 can be implemented typically by a processor and memory 15. The management information again can have an indication of energy consumption status in a format compatible with the format of the stored model. This can enable such information to be exchanged with external management parts at other locations, or with management parts at different layers, or from different vendors, all in the same format or at least in compatible formats so that format adapters are not needed, at least not for the energy consumption status information. There may be a direct path as shown between the another management part 20 and the stored model, to enable the another management part to update or to use the model, or optionally the access to the stored model may be exclusively via the management part 10. The stored model may be implemented as a centralised database or implemented in a distributed manner as convenient.

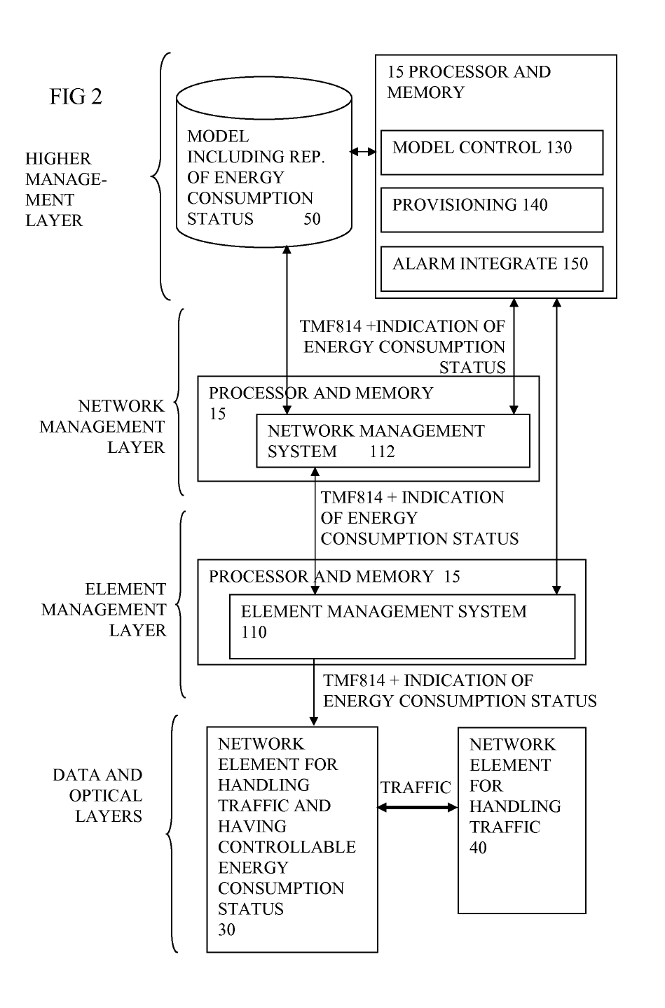

### FIG. 2, a Second Embodiment Having Management Layers and Using TMF 814

FIG. 2 shows a schematic view showing similar features to those of FIG. 1, and in this case the management parts are shown in layers. There is an element management layer, a network management layer and a higher management layer. The network elements 30 and 40 are shown as being in data and optical layers. The management part 10 of FIG. 1 corresponds to the NMS 112 and the EMS 110 shown as being in the network management layer and element management layer respectively. There may be many such EMSs managed by a single NMS, and there may be many NMSs for different parts of the network, or for parts owned or operated by different operators for example.

The NMS and the EMS may be implemented typically by a processor and memory 15. There are management paths between these parts for passing information in the format specified by TMF814, extended to include explicit indication of energy consumption status. Examples of how this format is extended are described in more detail below. This extended format is also used for the stored model.

The another management part of FIG. 1 corresponds in this case to the parts shown for model control 130, for provisioning 140 and for alarm integration 150. Other such higher management layer functions can be envisaged. They may be implemented using a processor and memory 15. As shown, there are management paths provided to pass the indications of energy consumption status between the EMS and the network elements, between the EMS and the NMS, and between the NMS or EMS and the management parts at the higher management layer. Although shown as part of the higher management layer, the stored model, or parts of it, may be implemented in other layers.

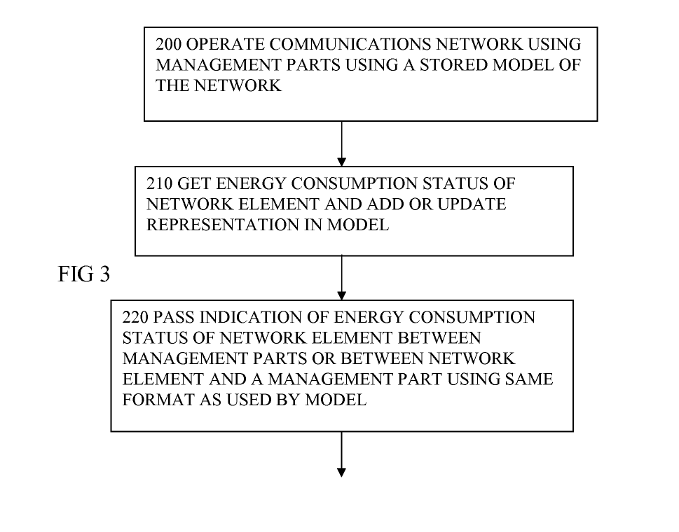

### FIG. 3, Steps According to an Embodiment.

FIG. 3 shows steps according to an embodiment, and such steps may be implemented using the apparatus of FIG. 1 or FIG. 2 or other embodiments. At step 200, the communications network is operated using the management parts and using the stored model, having explicit representations of energy consumption status of one or more of the network elements. At step 210, there is a step of getting energy consumption status of a network element (either actual status from a network element or from its EMS, or a desired status, from an NMS for example) and adding this information to the stored model, to update the stored model. At step 220 there is a step of passing an indication of energy consumption status between management parts or between a network element and a management part using the same format as used by the model or at least in compatible formats so that format adapters are not needed, at least not for the energy consumption status information. This addition of explicit energy consumption status information to the model and the exchange of this information by management parts in the same format, can help enable the management to become energy aware more efficiently without adding undue complexity. After step 220, there can be many other steps, such as using the information in various ways, repeatedly updating the stored model to keep it up to date, and so on.

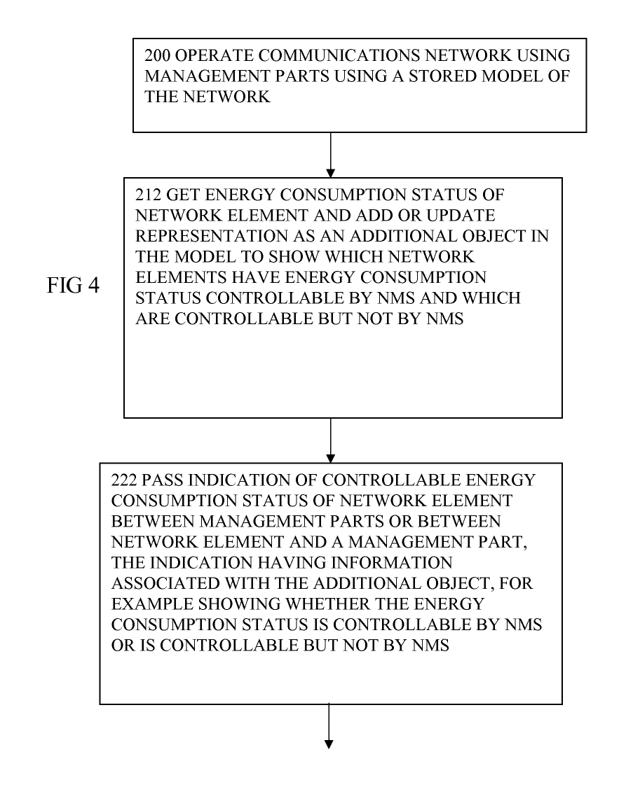

FIG. 4, Steps According to a Further Embodiment with an Additional Object.

FIG. 4 shows steps similar to those of FIG. 3 and adding the energy consumption status as an additional object, so as to avoid altering existing objects, so as to maintain backward compatibility. Thus step 210 is replaced by step 212 which involves adding or updating the model with an additional object corresponding to a network element having controllable energy status. In some cases this object shows whether the status is controllable externally by the NMS for example, or whether the status is controllable but only by the element itself or its EMS, and not externally by the NMS.

Step 220 is replaced by step 222 in which the indication passed between management parts or between the network element and a management part has information associated with the additional object to show whether the status is controllable externally by the NMS for example, or whether the status is controllable but only by the element itself or its EMS, and not externally by the NMS. Again this information is passed using the same format as used by the model or at least in compatible formats so that format adapters are not needed, at least not for the energy consumption status information.

A network element can be composed of one or multiple physical components. The stored model, if represented in objects, can be supplemented with an Energy Aware Object (EAO). This is an additional representation of a network element or a physical component of a network element, whose energy consumption status can be externally controlled. The EAO can assume different energy status.

The Energy Aware Object can represent a logical abstraction of a physical component which energy status can be externally controlled. An EAO should have the following attributes: Type: and Status.

Type represents the physical component which energy status can be externally controlled (for example clock, voltage,) or internally controlled (for example line ports, fans.). Status indicates the state assumed by the EAO. A state depends on a particular hardware configuration, and hence details can be deduced.

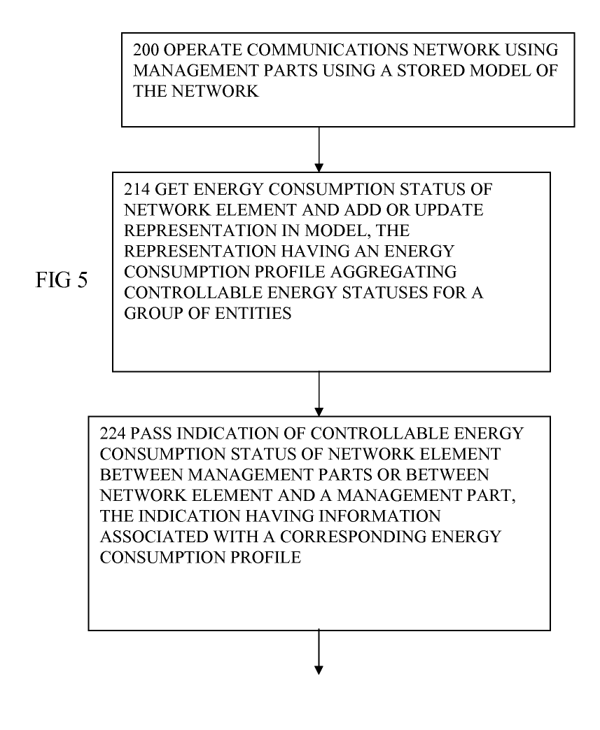

FIG. 5, Steps According to a Further Embodiment with an Energy Profile

An aggregation of energy consumption status information of a group of EAOs is herein called an Energy Profile. A network element should be able to export to an EANMS information about how many different Energy Profiles are possible for it. The network element should also be able to export to the EANMS information about the current Energy Profile. In some cases the node is able to set its Energy Profile to a desired value. One example of a group of network elements is the line ports on a line interface card. If there are four ports, each of which is controllable to have a low power standby mode, or an active mode, then there are sixteen possible combinations of standby or active status. But the overall consumption of the line card will be one of only five values, depending on whether the number of active ports is 0, 1, 2, 3 or 4. Thus an energy consumption profile for the card could have one of five possible values. Thus by aggregating the energy consumption statuses of the group, the amount of information can be reduced, and an amount of unnecessary detail, in this case the information of which of the ports is active, can be reduced. The benefit of this in terms of improving efficiency of information exchange between management parts, increases as the size and complexity of the network increases.

FIG. 5 shows steps similar to those of FIG. 3, altered to have the energy profile as part of the indication so as to aggregate information to reduce the need to pass separate indications for many elements, and to reduce the need to handle details of implementation of energy consumption control in different ways by different elements, so as to improve efficiency Thus step 210 is replaced by step 214 which involves adding or updating the model with an energy consumption profile which aggregates the controllable energy statuses for a group of network elements.

Step 220 is replaced by step 224 in which the indication passed between management parts or between the network element and a management part has an energy consumption profile which aggregates the controllable energy statuses for a group of network elements. Again this information is passed using the same format as used by the model or at least in compatible formats so that format adapters are not needed, at least not for the energy consumption status information.

An Energy Profile (EP) can represent a list of profiles which a network element such as an ME (ManagedElement) is able to support. An EP can be an object having, in addition to the attributes identified in Common Attributes, the following attributes:
1 Is Extensible. This attribute represents whether an EAO is extensible or not
2 Not Extensible EAO List. This attribute represent a list of EAO that cannot be modified, their status is profile specific.
3 Extensible EAO List This attribute represents a list of EAO that can be modified, their status can be changed.
4 Associated Resource List. This attribute represents a list of of Equipments (and the list of the ports, if the profile is extensible) associated with this Energy Profile object.

The energy status of some EAO (only ports) can be modified, independently of the profile, provided that the profile is “extensible”. This attribute shall emit notifications when a status of a port changes.

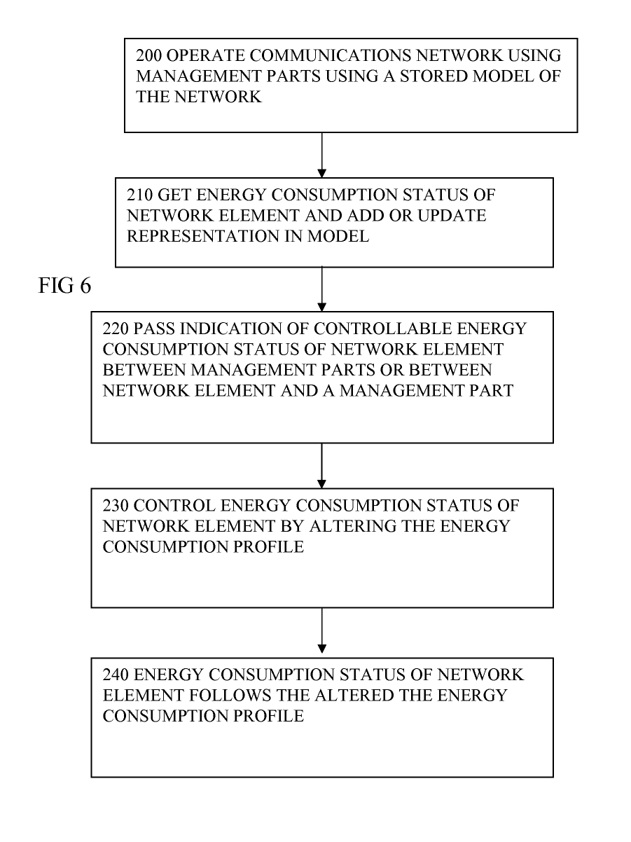

FIG. 6, Steps According to a Further Embodiment with Control Steps

FIG. 6 shows steps similar to those of FIG. 3 and adding a subsequent step 230 of controlling the energy consumption status of a network element by altering a desired energy consumption profile, using the model, or by sending a command to the network element. At step 240, the network element implements the change itself, either in response to receiving the command having the indication of desired profile in the same format as used in the model, or by having the network element or its EMS, detect a change in the model and implementing the change to maintain consistency with the model.

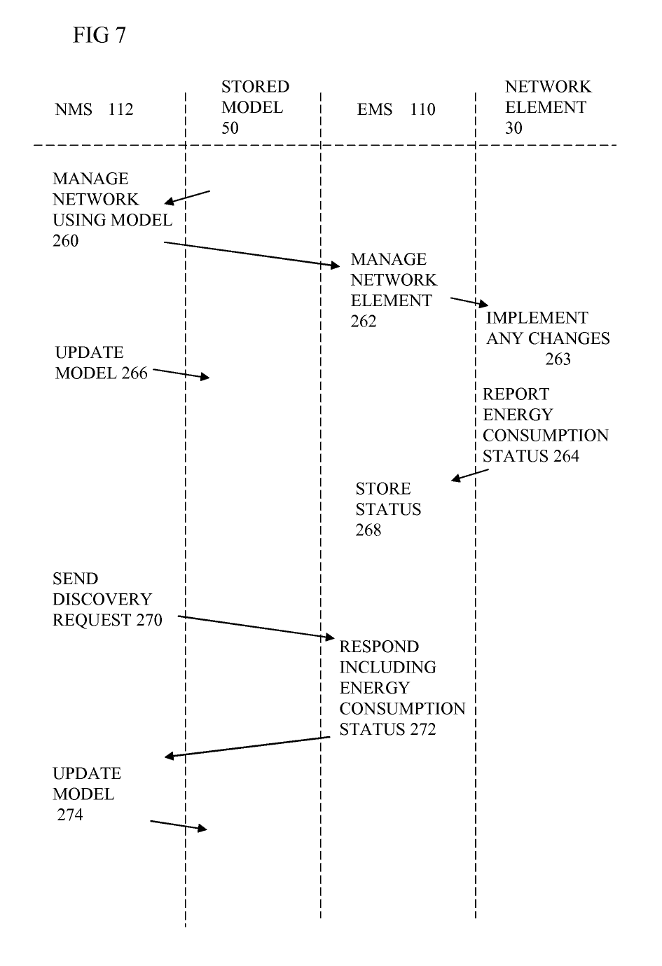

### FIG. 7, Time Chart of Embodiment Having Exchanges Between NMS and EMS

FIG. 7 shows a time chart of steps according to an embodiment having exchanges of information between the NMS and EMS and other parts. This may be implemented using apparatus shown in the embodiment of FIG. 2 or other embodiments. Time flows down the figure. A left column shows actions of the NMS 112. A next column to the right shows actions of the stored model, a next column to the right shows actions of the EMS 110, and a right most column shows actions of a network element 30. At step 260 the NMS manages the network using information from the stored model. The NMS may update the model directly at step 266. The managing may involve sending information to the EMS. At step 262 the EMS receives the information from the NMS and manages the network element accordingly. This may involve sending information to the network element indicating changes, which at step 263 are implemented by the network element. Periodically, or in response to a prompt from the EMS, at step 264 the network element reports its energy consumption status to the EMS, using the same format as the model. The EMS stores this information in its inventory at step 268. At step 270, the NMS sends a discovery request to the EMS. The EMS responds at step 272 by sending the energy consumption status or energy profile for the relevant network element or group of elements to the NMS. The NMS may update the model at step 274.

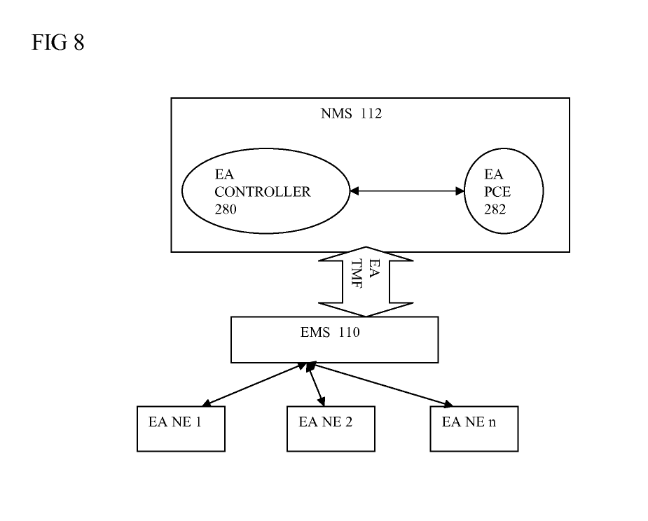

### FIGS. 8, 9, 10 Examples Showing NMS Controller and PCE

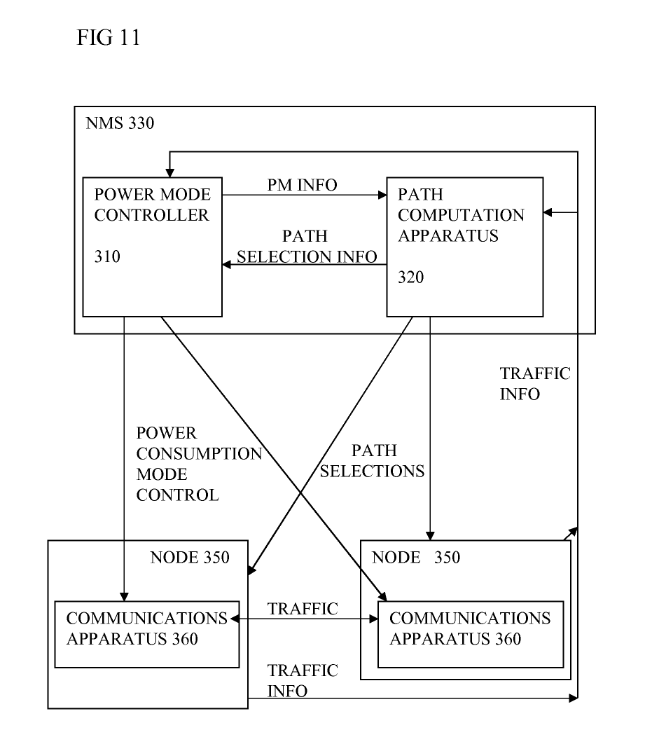

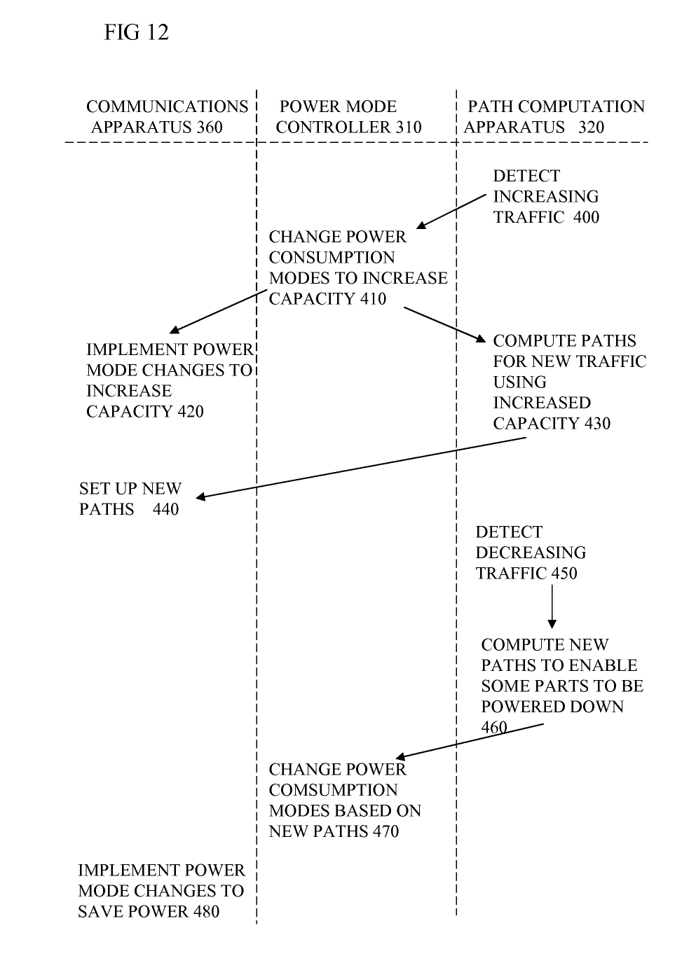

FIG. 8 shows an example having an EMS 110 and an NMS 112, the EMS being coupled to many energy aware network entities EANE 1, 2 . . . n. The NMS 112 has an energy aware controller 280 and an energy aware PCE 282. These parts exchange energy consumption status information with the EMS via an interface using the TMF standard enhanced with energy consumption status information in the same format, as described in more detail below. The EA PCE can use the energy consumption status information to carry out energy aware routing for example, as described below in more detail in relation to FIGS. 11 and 12. The energy aware controller can be arranged to determine when energy consumption can be reduced safely, based on levels of traffic and knowledge about the possible energy consumption status or profiles. The controller can send commands to the EMS to control the status or profiles of the network elements which have controllable energy consumption status.

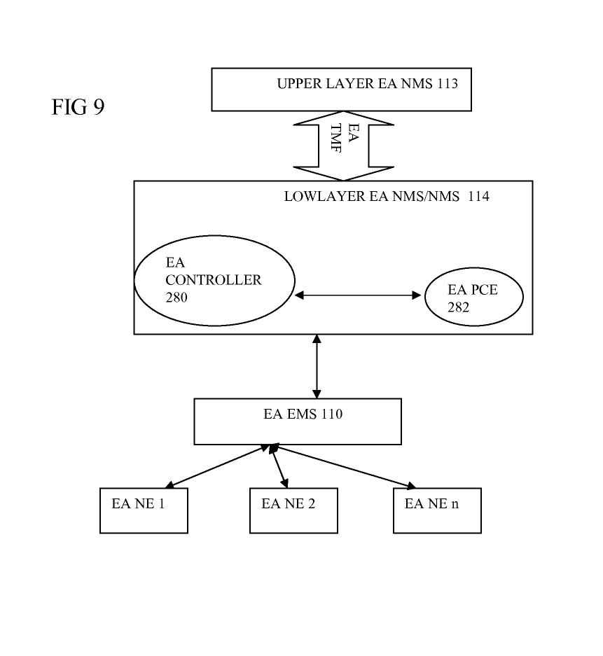

In FIG. 9, a similar example is shown, but in this case the NMS 112 is divided into an upper layer 113 and a lower layer 114. This is known as a meshed model. The different parts of the NMS in the different layers can exchange energy consumption status information with the EMS via an interface using the TMF standard enhanced with energy consumption status information in the same format.

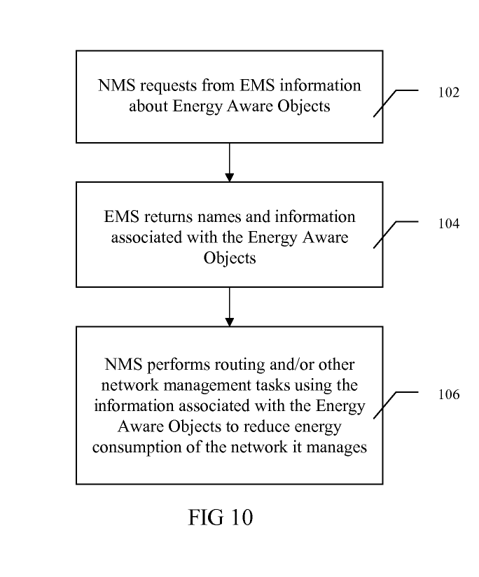

FIG. 10 shows method steps according to an embodiment. At step 102 the NMS requests from the EMS information about energy aware object. At step 104, the EMS returns names and information associated with the energy aware objects. At step 106 the NMS carries out management such as routing or other network tasks using the information associated with the energy aware objects to reduce the energy consumption of the network.

### FIGS. 11, 12 Embodiments Combining Power Consumption Control and Energy Aware Path Computation

FIG. 11 shows a schematic view of a network according to an embodiment. An NMS 330 has amongst others, a power mode controller 310 and a path computation apparatus 320. References to power mode or power consumption mode are intended to equate to energy consumption status. These can be implemented as software functions running on a server or any kind of processor for example. The network has nodes 350 which have communications apparatus 60 for handling the communications traffic in the network. The communications apparatus can be for example systems, or cards or circuits which can be capable of being operated in different power consumption modes which provide different levels of performance in passing the communications traffic. The power consumption modes can be power states in accordance with IEEE1621, DMTF, ACPI or EMAN or any other kind of power consumption mode. The nodes can be dedicated to the network, or may be incorporated in equipment having other functions, such as household goods, vehicles, or factory equipment for example.

The power mode controller is coupled to receive path selection information from the path computation apparatus, and to receive traffic information such as traffic loads, from the nodes 350 of the network. The path mode controller is arranged to output control signals to the communications apparatus to control its power consumption mode. This control can be carried out based on information about traffic load and according to information about the paths selected. The path selection apparatus is coupled to receive traffic load information from the communication apparatus and to receive information about power consumption modes of the communications equipment from the power mode controller. The path selections for new traffic demands can then be made by the path computation apparatus based on the traffic load information and on information about the power consumption modes of the communications apparatus. The path selection can use any type of path selection algorithm, adapted to make use of the power consumption mode information, and an example is described in more detail below. As discussed above, by combining path computation and the control of power consumption modes, the overall power consumption of the network can be reduced for a given amount of traffic compared to known techniques where the communications apparatus control their own power consumption mode by detecting their own traffic load.

FIG. 12 shows a time chart of some additional steps in operating a network according to an embodiment, such as the embodiment of FIG. 11 or other embodiments. This is to illustrate the steps in using the energy consumption status information for energy aware path computation and to show an example of the additional feature of deciding the order in which steps of path computation and power consumption mode control are made, depending on whether traffic load is increasing or decreasing. In FIG. 12 the left hand column shows actions of a communications apparatus 360, the central column shows actions of the power mode controller 310, and the right hand column shows actions of the path computation apparatus 320. Time flows downwards.

At step 400 the increasing overall traffic load is detected by the path computation apparatus to be sufficient to need additional capacity. This information is passed to the power mode controller which at step 410 changes power consumption modes of selected communications apparatus to increase performance and thus provide more capacity. At step 420, these changes are implemented at the respective communications apparatus. Then the path computation apparatus computes new paths for new traffic demands using the increased capacity at step 430. These new paths are set up at step 440 using the communications apparatus. Some time later, there is detection at step 450 of decreasing traffic load overall, sufficient that there is scope for saving power consumption by changing power consumption modes. Now there is a different order of steps. At step 460 the path computation is carried out first, to see if traffic can be rerouted to enable some parts to be powered down. Then at step 470 the power consumption mode control is carried out based on the rerouted traffic, so that some communications apparatus can be powered down to a lower power mode. These power mode changes are implemented at step 480 at the apparatus to reduce the overall power consumption. In some cases traffic can be concentrated to use fewer communications apparatus, which may involve increasing the power consumed by some apparatus, which is still useful if it enables an overall reduction in power consumption by the network. This is enabled by the cooperation between the power consumption mode controller and the path computation apparatus set out above.

### Examples of Same Format Using TMF 814

The TeleManagement Forum (TMF) is a standard organization that aims to provide guidance and practical solutions to improve the management and operation of information and communications services. The Multi-Technology Network Management (MTNM) program of the TMF provides a common solution to manage multi-technology networks (including SONET, SDH, DWDM, PDH ATM, Ethernet and others). TMF814 is a CORBA-based protocol specifically designed for network management.

The protocols used for network management generally have to support multi-vendor, multi-technology communication. Several access methods support network device management, with some of the most common methods being SNMP, Windows Management Instrumentation (WMI), CMIP and CORBA. The type of access method used depends on the type of information the needs to be transferred, security, reliability, speed and other priorities that the service requester has.

For communication with the network elements several protocols can be used, for instance SNMP, TCP/IP and CLNS can be used with network elements. CORBA based protocols are used for communication between the Element Management Layer the Network Management Layer and the Higher Management Layer uses CORBA based protocols. FIG. 2 described above outlines the communication paths between these different Management layers.

TMF814 already models the various manageable physical components of the Network Element (fan, fuse panel . . . ) in SD1-10, see ref [2]. Some embodiments involve an extension to TMF814 model to enable the Network Management System to manage the network more efficiently in terms of power consumption and traffic. How the Network Management System (NMS) models and uses the additional information depends on the implementation and need not be described in more detail here.

In some of the embodiments there is a new object added to the model of the network and a new object manager. This can help ensure full backward compatibility as no modifications need be introduced to existing objects. The proposed model is easily extendable to other network elements.

The TMF modelling concepts help manage many disparate network technologies through the single interface using one model and consistent operations paradigm. A coarse grain approach has been used for the definition of the new extended interface (by adopting the existing Facade Design Pattern and a Singleton design Pattern for the Facade objects, extended to CORBA objects, as set out in the TMF document SD1-27_overview_NMLEML_Interface.pdf). The coarse grain approach means that access to the objects modeled through the interface is done with the appropriate Object Manager (as a consequence a new object manager has been defined having services to obtain energy consumption related data about the objects in the network managed by the EMS via its detailed object model).

The TMF 513 Version 3.1 Multi-Technology Network Management Business Agreement R3.5 contains all the Use Cases which aim to define the interaction across Network management System (NMS) and Element Management System (EMS) and span from to the session management use case up to Control Plane, Connectionless Management use case and so on.

One example described below extends a sub Use Case of Discovery and Inventory Use Cases (UC 7.4), and precisely the Use Case 7.4.3: NMS discovers the EMS network inventory.

Currently UC 7.4 provides the following sub use Cases:

Use Case 7.4.1: NMS registers to receive network updates information from the EMS
Use Case 7.4.2: NMS resynchronizes its database with the EMS Refer to Use Case 7.4.3: and Use Case 7.4.4:
Use Case 7.4.3: NMS discovers the EMS network inventory
Use Case 7.4.4: NMS queries EMS concerning inventory
Use Case 7.4.5: EMS notifies NMS of inventory change

Below is shown an extended version of the Use Case 7.4.3: NMS discovers the EMS network inventory:

| | |
|---|---|
| Use Case | NMS discovers the EMS network inventory |
| Name | |
| Summary | The NMS sends a series of queries to the EMS, with the |
| | intent of discovering the network inventory managed by |
| | the EMS. |
| Actors | NMS |
| Pre- | 1) The NMS has executed Use Case 7.2.2: NMS creates a |
| conditions | session with EMS. |
| | 2) The NMS has not yet discovered the inventory managed |
| | by the EMS. |
| Begins when | The NMS sends the first inventory query to the EMS. |
| Description | There are many possible ways for the NMS to obtain the |
| | EMS's inventory. Two possibilities are given below, |
| | however the queries can be sent in many different |
| | combinations. |
| | Although the requests themselves are synchronous, the |
| | NMS may send subsequent inventory requests to the EMS |
| | before receiving a response to a pending request. |
| | Although not mandated by this use case, the NMS may |
| | want to start receiving EMS inventory updates at the time |
| | the discovery process begins. Once the NMS has received |
| | responses to the inventory queries, the NMS can analyze |
| | the inventory update notifications that it received during the |
| | discovery process (if any) and updates its inventory |
| | accordingly. |
| | (Approach A: Discovery of subnetworks' details such |
| | as edge points, cross connections, protection details, |
| | performance counters, flow domain fragments) |
| | 1) The NMS sends a request to retrieve EMS information |
| | from the EMS. |
| | The EMS returns the name, user label, native EMS name, |
| | owner, type and software version of the EMS. |
| | 2) The NMS sends a request to retrieve Subnetworks |
| | from the EMS. |
| | The EMS returns the names and associated information for |
| | the subnetworks that it manages. |
| | 3) The NMS sends a request to retrieve Managed |
| | Elements from the EMS. |
| | For each request, the EMS returns the names and |
| | associated information concerning the Managed Elements. |
| | 4) For each Managed Element, the NMS sends a request |
| | to retrieve the Physical Termination Points (including |
| | FTPs) from the EMS. |
| | For each request, the EMS returns the names of the |
| | Physical Termination Points (PTPs) and information |
| | associated with the PTP, including a indication of whether |
| | the PTP is on the edge of the containing subnetwork. |
| | Alternatively for each termination point (PTP or CTP), the |
| | EMS sends a request to retrieve the contained |
| | Performance Monitoring Points (PMPs) within a |
| | specified PTP or CTP from the EMS. |
| | For each request, the EMS returns the names of the |
| | contained PMPs and associated information. |
| | 5) For each subnetwork, the NMS sends a request to |
| | retrieve the Topological Links within a specified |
| | subnetwork from the EMS. |
| | The EMS returns the names and associated information for |
| | the topological links associated with a subnetwork. |
| | 6) The NMS sends a request to retrieve the top-level |
| | Topological Links from the EMS. |
| | The EMS returns the names and associated information for |
| | each of the top-level topological links. |
| | 7) For each PTP, the EMS sends a request to retrieve the |
| | contained CTPs within a specified PTP or CTP from the |
| | EMS. |
| | For each request, the EMS returns the names of the |
| | contained CTPs and associated information. If the CTP |
| | contains other CTPs, this information will also be |
| | returned. |
| | 8) For each identified subnetwork, the NMS sends a |
| | request to retrieve the Subnetwork Connections from the |
| | EMS. |
| | For each request, the EMS returns the names of the |
| | subnetwork connections and associated information. |
| | 9) For each subnetwork connection, the NMS sends a |
| | request to retrieve the Routes. |
| | 10) For every Managed Element the NMS sends a request |
| | to retrieve the Protection Groups from the EMS. |
| | For each request, the EMS returns the names of the |
| | protection groups and associated information for the |
| | protection groups it manages within the Managed |
| | Element specified. |
| | 11) For every Managed Element the NMS sends a request |
| | to retrieve Cross-Connects from the EMS. |
| | For each request, the EMS returns the associated |
| | information for the crossconnects it manages within the |
| | Managed Element specified. |
| | 12) For every subnetwork the NMS sends a request to |
| | retrieve TP Pools from the EMS. |
| | For each request, the EMS returns the names and |
| | associated information for the TP Pools it manages within |
| | the subnetwork specified. |
| | 13) If supported by the EMS, the NMS sends a request to |
| | retrieve Traffic Descriptors from the EMS. |
| | The EMS returns the names and associated information for |
| | the traffic descriptors it manages. |
| | 14) If supported by the EMS, for every Managed Element |
| | the NMS sends a request to retrieve Equipment Holders |
| | and Equipment from the EMS. |
| | For each request, the EMS returns the names and |
| | associated information for the equipment holders and |
| | equipment it manages in the ME specified. |
| | 15) Refer to Use Case 7.12.5: NMS retrieves PM |
| | capabilities of a Managed Element (ME). |
| | 16) The NMS sends a request to retrieve Flow Domains |
| | from the EMS. |
| | The EMS returns the names and associated information for |
| | the Flow Domains that it manages. |
| | 17) For each identified Flow Domain, the NMS sends a |
| | request to retrieve the Flow Domain Fragments from the |
| | EMS. |
| | For each request, the EMS returns the names of the Flow |
| | Domain Fragments and associated information. |
| | 18) For each Flow Domain Fragment, the NMS sends a |
| | request to retrieve its Flow Domain Fragment Route. |
| | 19) For every Managed Element the NMS sends a request |
| | to retrieve Matrix Flow Domains from the EMS. |
| | For each request, the EMS returns the names and |
| | associated information for Matrix Flow Domains it |
| | manages within the ME specified. |
| | 20) For each Matrix Flow domain, the NMS sends a |
| | request to retrieve Matrix Flow Domain Fragments. |
| | For each request, the EMS returns the names and |
| | associated information for Matrix Flow Domain Fragments |
| | it manages within the ME specified. |
| | 21) For each subnetwork, the NMS sends a request to |
| | retrieve from the EMS the Energy Aware Object (EAOs) |
| | that it manages. |
| | For each request, the EMS returns the names and |
| | information associated with it. |
| | (Approach B: Discovery of subnetworks with their |
| | edge points only. This is a minimal set of requests |
| | which can also support gathering of some energy |
| | consumption information) |
| | 1) The NMS sends a request to retrieve the EMS |
| | information from the EMS. |
| | The EMS returns the name, user label, native EMS name, |
| | owner, type and software version of the EMS. |
| | 2) The NMS sends a request to retrieve Subnetworks |
| | from the EMS. |
| | The EMS returns the names and associated information for |
| | the subnetworks that it manages. |
| | 3) For each subnetwork, the NMS sends a request to |
| | retrieve from the EMS the |
| | Physical Termination Points (PTPs) which are the edges |
| | of a specified subnetwork. |
| | For each request, the EMS returns the names of the edge |
| | points and information associated with it. |
| | 4) The NMS sends a request to retrieve the top-level |
| | Topological Links from the EMS. |
| | The EMS returns the names and associated information for |
| | each of the top-level topological links. |
| | 5) For each PTP, the EMS sends a request to retrieve the |
| | contained CTPs within a specified PTP or CTP from the |
| | EMS. |
| | For each request, the EMS returns the names of the |
| | contained CTPs and associated information. If the CTP |
| | contains other CTPs, this information will also be returned. |
| | 6) For each identified subnetwork, the NMS sends a |
| | request to retrieve the Subnetwork Connections from the |
| | EMS. |
| | For each request, the EMS returns the names of the |
| | subnetwork connections and associated information. |
| | 7) If supported by the EMS, the NMS sends a request to |
| | retrieve Traffic Descriptors from the EMS. |
| | The EMS returns the names and associated information for |
| | the traffic descriptors it manages. |
| | 8) For each subnetwork, the NMS sends a request to |
| | retrieve from the EMS the Energy Aware Object (EAOs) |
| | and Energy profile (EP) that it can manages. |
| | For each request, the EMS returns the names and |
| | information associated with it. |
| Ends when | In case of success: |
| | The NMS has received the last response to the requests |
| | that it sent the EMS. |
| | In case of failure: |
| | The NMS has determined requests have been |
| | acknowledged or have timed out, and at least one of the |
| | requests has timed out or was acknowledged in the |
| | negative (the EMS could not or would not return the |
| | requested information). |
| Post- | In case of success: |
| conditions | The NMS has collected the requested inventory |
| | information from the EMS. |
| | In case of failure: |
| | The NMS has not collected the inventory information that it |
| | requested. |
| Exceptions | 1) Communication failure between the NMS and the EMS. |
| | 2) The NMS may include incorrect or unknown information |
| | in its queries to the EMS. |
| | 3) Entity not found: when an input parameter references an |
| | object that does not exist. |
| | See Use Case 7.4.2: NMS resynchronizes its database |
| | with the EMS. |
| | 4) Query unknown or not supported. |
| | 5) Unable to comply. |

Note that the extensions are essentially found in the description in item 21 for Approach A and item 8) for Approach B. In a preferred embodiment a Network Management System (NMS) requests from an Element Management System (EMS) information about Energy Aware Objects. In response the EMS returns names and information associated with the Energy Aware Objects. The NMS performs routing and/or other network management tasks using the information associated with the Energy Aware Objects to reduce energy consumption of the network it manages.

From a Network management point of view, in order to save energy, it is important to know if a node is able to modify its power state or not. The NMS can, in example, route on the node not “EA” all the nightly traffic and switch off the node, or card, that are “EA” in order to save energy and then, money. Some embodiments extend one of the more common standards used by an NMS to communicate to an EMS. The extension can be fully backward compatible and can be extendable to other object typology.

### Energy Consumption Modes

Typically some of the most important factors in determining power consumption in any design are the system Clock Speed and the system Supply Voltage. Switching power dissipated by a device, i.e. the dynamic power consumption expression is:

P=CV²f

Dynamic power dissipation is proportional to the square of operating voltage and linearly proportional to operating frequency and load capacitance. Therefore by lowering clock frequency, dynamic power dissipation decreases linearly, and by reducing supply voltage, an exponential lowering can be obtained.

Note: whole Power Consumption of a given device is expressed by P=C V² f+V I_{static} where I_{static} is static (e.g. leakage) current. The reduction of the static current is a mere technological step achievable for instance by shrinking die (e.g. from 45 nm to 28 nm, etc.) or, when applicable, by other technological improvements such as Electro-Optical ICs (EPICs) introduction. Note: less power consumption means less heat output, allowing the cooling fans to be throttled down or turned off, reducing noise levels and further decreasing overall system power consumption.

Power Modes can be applied by means of actual Traffic Load measurement, then retrieving the information for slowing-down resources or even shutting-down unnecessary resources when possible, under the control of an Energy Aware Control Layer.

Multiple levels of Power Modes can be envisaged such as Full Power/Full Performances, Medium Power/Medium Performances, Low Power/Reduced Performances, Fast Sleeping, Deep Sleeping, Standby, Off, each characterized by an additional power saving but also by reduced performances and increased wake up time.

### Power Consumption Modes Examples

Power Consumption Modes definition, terms and granularity may depend on the product type. Any of the following described modes can apply at System, at Card, as well as at single Circuit Portion level (e.g. a given interface, engine, etc.) and some of them can be extended: for instance multiple Low-Power modes can be possible, according to the given circuitry. The number and types of modes can be a function of the traffic load, potential power saving, and wake-up promptness. Two main categories can be identified: Operational Modes and Sleeping Modes.

### Operational Modes:

Operational (or On) Modes are states in which the device completely or partially performs its intended duties. On-Modes Power Management can be categorized by at least three terms:
On-Maximum: Operational state with all options applied (e.g. maximum clock speed, max supply voltages, all ancillary functions on such as e.g. external synch, etc.).
On-Normal: Operation state with a configuration such that maximum traffic load is achieved but some ancillary function e.g. external synch is off.
On-Low Power: Operational state with reduced traffic load capability (e.g. reduced supply voltage, clock, memory banks, etc.). May be possible to set several On-Low Power Modes, as an example: 9 Gbps, 8 Gbps, . . . 1 Gbps, etc.

### Sleeping Modes

Sleeping Modes are states in which the equipment, the card or the circuit portion is not operative, i.e. cannot perform either completely or partially its intended duties. It is ready to resume an Operational Mode, within a given “wake-up” time, through the use of remote control or another signal (e.g. local receivers or tails detects some traffic) according to the sleeping mode and implementation. According to power saving and wake-up promptness, Sleeping Modes may be:
Fast Sleep: no traffic can run, but most of circuitry is active, such as receivers are listening for traffic while transmitters are off, and/or SW/HW reset is applied to part/whole circuitry. This mode is stacked just below the lowest of the On-Low Power modes.
Deep Sleep: most circuitry is inactive, such as both receivers and transmitters are off, and/or HW/SW reset is applied to part/whole circuitry. Moreover reduced or null Vdd may apply to some parts of circuitry.
Stand-by (or Soft-Off): major equipment parts are switched off via remote control or command, but some minimal circuit is still on (i.e. a sort of heart-beating mode, where for instance just a μP is running)
Power-Off Mode (or Hard-Off): Power-off mode has almost null power consumption when the device is connected to an electrical supply. Power-Off mode may apply Vdd off at the whole card by remote control, but some very minimal residual power may be required to supply electronic switches.

### Energy Aware NMS

This method makes use of an Energy Aware management entity capable of minimizing P_active, and maximizing Low Power Modes adoption without jeopardizing network performances and QoS, by means of smart management policy, controlling entering and exiting the PMM states.

Energy Aware management policy shall implement energy aware routing protocols to maximize saving opportunities by filling as much as possible certain communication resources so to put in Low-Power or Sleeping Modes as much as possible of remaining resources.

At Node or Network level, the Energy Aware NMS can compute the optimal Traffic Routing and Power Management Mode for each device under control.

For optimal working of an Energy Aware Network, the Energy Aware Network Management System can take control over traffic by routing it by an energy aware perspective, by identifying any alternative path, and by controlling the entering and exiting of the various power consumption modes of the energy aware network elements under control. For this purpose the EA NMS should know the Network Topology and the Actual Traffic Load, as well as for example data throughput, transition time, latency and power consumption of each power management state of each EA network element under control, in order to maximize power saving without affecting the QoS. For instance, by knowing how long it takes to get in and out a certain sleeping modes, it will do so to make traffic routing at the right timing without jeopardizing QoS.

Other variations can be envisaged within the claims.

1. A method of operating a communications network having network elements for handling data traffic and having management parts for managing the network elements using a stored model which represents the communications network in a format, at least one of the network elements having an energy consumption status which can be controlled, the method comprising:
representing the energy consumption status of the at least one of the network elements in the stored model; and
passing an indication of the controllable energy consumption status of at least one of the network elements between one of the management parts and either of: another of the management parts and; at least one of the network elements,
wherein the indication has a format which is compatible with the format of the model.

2. The method of claim 1, the indication comprising which of the network elements has an energy consumption status controllable by the network management system, and which of the network elements has an energy consumption status which can be controlled, but not externally, by the network management system.

3. The method of claim 1, the representation of energy consumption status in the stored model comprising an object representing an energy consumption status of a respective one of the network elements, and the indication comprising information associated with the object.

4. The method of claim 1, the representation of energy consumption status in the stored model comprising an energy consumption profile for a group of the network elements, the energy consumption profile representing an aggregation of the controllable energy consumption statuses of the network elements in the group, and the indication comprising information associated with the energy consumption profile.

5. The method of claim 4, comprising updating the energy consumption profile according to a change in the controllable energy consumption status detected at one of the network elements of the group.

6. The method of claim 4, comprising controlling the energy consumption status of the network elements by the steps of altering the energy consumption profile, and causing the energy consumption statuses of the group of network elements to adapt to correspond to the altered energy consumption profile.

7. The method of claim 1, the management parts comprising a network management system, and the step of passing comprising sending a discovery request from a network management system and receiving in response the indication.

8. The method of claim 1, the management parts comprising an element management system for managing at least one of the network elements, the passing step comprising passing from the element management system, the indication in respect of the controllable energy consumption status of the network elements managed by the element management system.

9. A nontransitory computer readable storage medium comprising a computer program that, when performed by a processor, carries out a method of operating a communications network having network elements for handling data traffic and having management parts for managing the network elements using a stored model which represents the communications network in a format, at least one of the network elements having an energy consumption status which can be controlled, the method comprising:
representing the energy consumption status of the at least one of the network elements in the stored model; and
passing an indication of the controllable energy consumption status of at least one of the network elements between one of the management parts and either of: another of the management parts and; at least one of the network elements,
wherein the indication has a format which is compatible with the format of the model.

10. An apparatus for use in a communications network, the communications network having network elements for handling data traffic and having management parts for managing the network elements using a stored model which represents the communications network in a format, at least one of the network elements having an energy consumption status which can be controlled, the apparatus comprising a processor and a memory, said memory containing instructions executable by said processor whereby said apparatus is operative to:
update the stored model with a representation of the energy consumption status of the at least one of the network elements in the stored model; and
pass an indication of the controllable energy consumption status of at least one of the network elements between one of the management parts and either of: another of the management parts and; at least one of the network elements,
wherein the indication has a format which is compatible with the format of the model.

11. The apparatus of claim 10, the indication comprising which of the network elements has an energy consumption status controllable by the network management system, and which of the network elements has an energy consumption status which can be controlled, but not externally, by the network management system.

12. The apparatus of claim 10, the representation of the energy consumption status in the stored model comprising an object representing an energy consumption status of the indicated network elements which have a controllable energy consumption status, and the indication comprising information associated with the object.

13. The apparatus of claim 10, configured to represent the energy consumption status in the stored model at least as an energy consumption profile for a group of the network elements, the energy consumption profile representing in a aggregated form the controllable energy consumption statuses of the network elements in the group, and the indication comprising information associated with the energy consumption profile.

14. The apparatus of claim 13, being operative also to update the energy consumption profile in the model according to a change in the controllable energy consumption status of one of the network elements of the group.

15. The apparatus of claim 13 being operative also to control the energy consumption status of the network elements by altering the energy consumption profile, and causing the energy consumption statuses of the group of network elements to correspond to the altered profile.

16. The apparatus of claim 10, comprising a network management system configured such that the passing of the indication comprises sending a discovery request and receiving the indication in response.

17. The apparatus of claim 10, comprising an element management system, the element management system being configured to manage at least one of the network elements, and being configured to pass the indication to the one of the management parts, the indication comprising the controllable energy consumption status of the network elements managed by the element management system.
